(19) United States
(12) Patent Application Publication
(10) Pub. No.: US 2016/0007527 A1
(43) Pub. Date: Jan. 14, 2016

(54) Section Knife

(71) Applicants: Mark Alan Collins, Swan, IA (US); Harry C. Deckler, JR., Indianola, IA (US)

(72) Inventors: Mark Alan Collins, Swan, IA (US); Harry C. Deckler, JR., Indianola, IA (US)

(73) Assignee: ALAMO GROUP, INC., Seguin, TX (US)

(21) Appl. No.: 14/858,493

(22) Filed: Sep. 18, 2015

Related U.S. Application Data
(62) Division of application No. 14/022,905, filed on Sep. 10, 2013.
(60) Provisional application No. 61/699,577, filed on Sep. 11, 2012.

(51) Int. Cl. A01D 34/13; B24B 3/36; B24B 3/58

(52) U.S. Cl. CPC A01D 34/13; B24B 3/586; B24B 3/361

(57) ABSTRACT

A method of manufacturing a section is formed from a blank having the perimeter of a truncated generally isosceles triangle. Each angled side of the truncated generally isosceles triangle includes a plurality of substantially semi-circular channels. The long axis of each substantially semi-circular channel is substantially parallel to the base of the truncated generally isosceles triangle. The top of the substantially semi-circular channel intersects the front surface of the section knife. The bottom of the substantially semi-circular channel intersects the back surface of the section knife. A cutting edge is formed at the intersection of the substantially semi-circular channel and the back surface of the section knife.

### CROSS REFERENCE TO RELATED APPLICATION

This patent application claims the benefit of Provisional U.S. Patent Application No. 61/699,577 filed Sep. 11, 2012, and is a continuing application (divisional) of U.S. patent application Ser. No. 14/022,905 filed Sep. 10, 2013.

### STATEMENT REGARDING FEDERALLY FUNDED RESEARCH AND DEVELOPMENT

The invention described in this patent application was not the subject of federally sponsored research or development.

### FIELD

The present invention pertains to a section knife used with agricultural machinery such as a combine harvester, a mower conditioner, a swather, a sickle mower as well as any hay or forage harvesting equipment which uses a reciprocating cutting mechanism to cut or harvest a variety of different crops such as cereal grains, hay, soy beans, irrigated grasses and field grasses.

### BACKGROUND

Section knives have been used for many years in mechanized farm machinery employing a reciprocating cutting mechanism to cut a variety of different crops. A prior art section knife 110 is shown in FIG. 1. Therein it may be seen that a typical prior art section knife has the perimeter of a truncated, generally isosceles triangle with a thickened base 114. On the angled edges 112, which extend upwardly from the thickened base 114, are a plurality of points 116. The points 116 are separated by V-shaped channels 118. The intersection 119 of the V-shaped channel 118 with the back surface 120 of the section knife 110 is sharpened to enable the cutting of the vegetable matter encountered by the sharpened edge 119 of the moving section knife 110.

Prior art section knives 110 must be changed frequently as the sharpened edge 119 becomes dull with frequent use. As the sharpened edge 119 loses its sharpness, the section knife 110 must absorb greater impact forces. Such greater impact forces often cause the section knives to break.

Various attempts have been made to extend the service life of section knives to include coating the section knives with metals known for their toughness or hardening the sharpened edge of the section knife using a variety of different metallurgical processes. Unfortunately, such coating or metallurgical treating of prior art knives have increased the cost of section knives and have only achieved limited success.

Accordingly, a current need remains in the art to provide a section knife which properly cuts the vegetable matter it encounters, has an increased service life, thereby reducing the cost to maintain the mechanized equipment on which the section knife is mounted, and can be manufactured for essentially the same cost as prior art section knives.

### SUMMARY

The unique geometry of the section knife of the present invention enables both the proper cutting of the vegetation encountered by the section knife and an increased service life.

The section knife of the present invention is made from a metal blank. The metal blank has both a back surface and a front surface. The perimeter of the metal blank is in the form of a truncated, generally isosceles triangle with a thickened base. The top point of the isosceles triangle is removed so the form of the metal blank is called a truncated, generally isosceles triangle for the purpose of this patent application. The thickened base of the truncated, generally isosceles triangle includes one or more mounting holes for connecting the section knife to a piece of machinery. Contiguous with the thickened base of the truncated, generally isosceles triangle are angled edges. Along each angled edge are formed substantially semi-circular channels. The long axis of each substantially semi-circular channel is substantially parallel to the thickened base portion of truncated, generally isosceles triangle shaped blank. Each substantially semi-circular channel intersects both the front and back surfaces of the blank. It is the intersection of the substantially semi-circular channel with the back surface of the blank forms a cutting edge on the section knife.

### BRIEF DESCRIPTION OF THE DRAWING FIGURES

A still better understanding of the section knife of the present invention may be had by reference to the drawing figures wherein:

FIG. 1 is a top plan view of a prior art section knife;

FIG. 2 is a top plan view of a preferred embodiment of the section knife of the present invention;

FIG. 2A is a view in partial section along line A-A of FIG. 2;

FIG. 3 is a top plan view of the front of a section knife blank before formation of the substantially semi-circular channels on each angled edge;

FIG. 4 is a schematic drawing illustrating the step of cutting the substantially semi-circular channel with a grinding or milling tool along the angled edge on one side of the section knife blank;

FIG. 4A is a schematic drawing illustrating the step of forming the substantially semi-circular channel with a crush roller or a forming die on one side of the section knife blank;

FIG. 5 is a top plan view of an alternate embodiment of the section knife of the present invention wherein the angled edges on either side of the section knife include a concave portion;

FIG. 6 is a top plan view of a second alternate embodiment of the section knife of the present invention wherein the substantially semi-circular channels are interspersed between groups of V-shaped channels; and

FIG. 7 is a top plan view of a third alternate embodiment of the section knife of the present invention where individual section knives are joined together at their thickened base.

### DESCRIPTION OF THE EMBODIMENTS

As indicated in the BACKGROUND portion of this patent application, section knives are used on various types of mechanical equipment using a reciprocating cutting mechanism to cut the stems or stalks of a wide variety of commercial crops. As the cutting equipment with the section knives mounted thereon moves through a field, the sharpened edges of the moving section knives encounter friction from a variety of sources. This friction causes the cutting edge of the section knife to lose its sharpness and thereby reduces the ability of the section knife to cut through vegetable matter such as plant stems or stalks. A dull section knife experiences greater forces and thereby becomes more subject to breakage. Accordingly, the dull section knives on the cutting equipment must be periodically replaced. The design of the section knife of the present invention has shown itself to be self-sharpening, thereby enabling the cutting of vegetable matter for a longer period of time than prior art section knives.

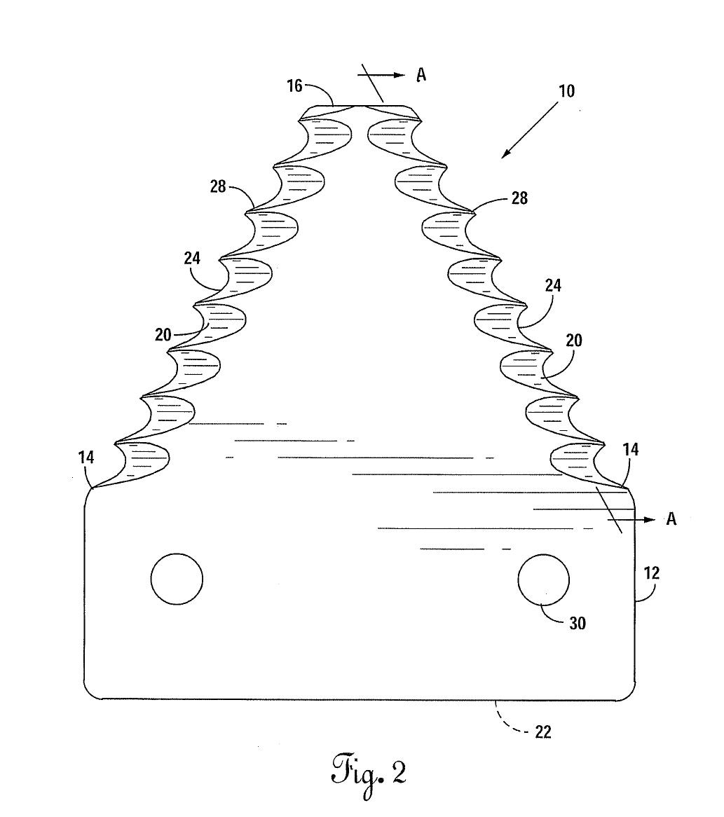

A top plan view of the section knife 10 of the present invention is shown in FIG. 2. Like some prior art section knives, the section knife 10 of the present invention generally has the perimeter of a truncated, generally isosceles triangle with a thickened base 12. Two angled edges 14 are contiguous with the thickened base 12 and extend upwardly and away from the thickened base 12 toward the top truncated portion 16 of the section knife 10.

The difference in the section knife 10 of the present invention from prior art section knives 110 is best seen in FIG. 2A. Therein it may be seen that the channels 20 formed in the angled edges 14 of the section knife 10 of the present invention have a substantially semi-circular half round, or half-circle shape. Further, the long axis of the substantially semi-circular shaped channel 20 is substantially parallel to the thickened base 12 of the truncated, generally isosceles triangle perimeter of the section knife 10. By use of the term “substantially parallel”, it has been found that if the long axis of the substantially semi-circular channel 20 is up to 10 degrees away from being perfectly parallel with the thickened base 12 of the truncated, generally isosceles triangle perimeter of the section knife 10, the section knife 10 will still operate in a satisfactory manner.

The term “substantially semi-circular” as used herein to describe the shape of channel 20 shall also include a half-hexagonal, a half-octagonal or a half-oval cross section. It is the intersection of the substantially semi-circular channel 20 with the back surface 22 of the section knife 10 that provides the cutting edge 24 which contacts the stem or stalk of a plant. The top of the substantially semi-circular channel 20 intersects the front surface 26 of the section knife 10. Between the substantially semi-circular channels 20 are ridges 28 which separate the substantially semi-circular channels 20 one from another along the angled edges 14 of the section knife 10.

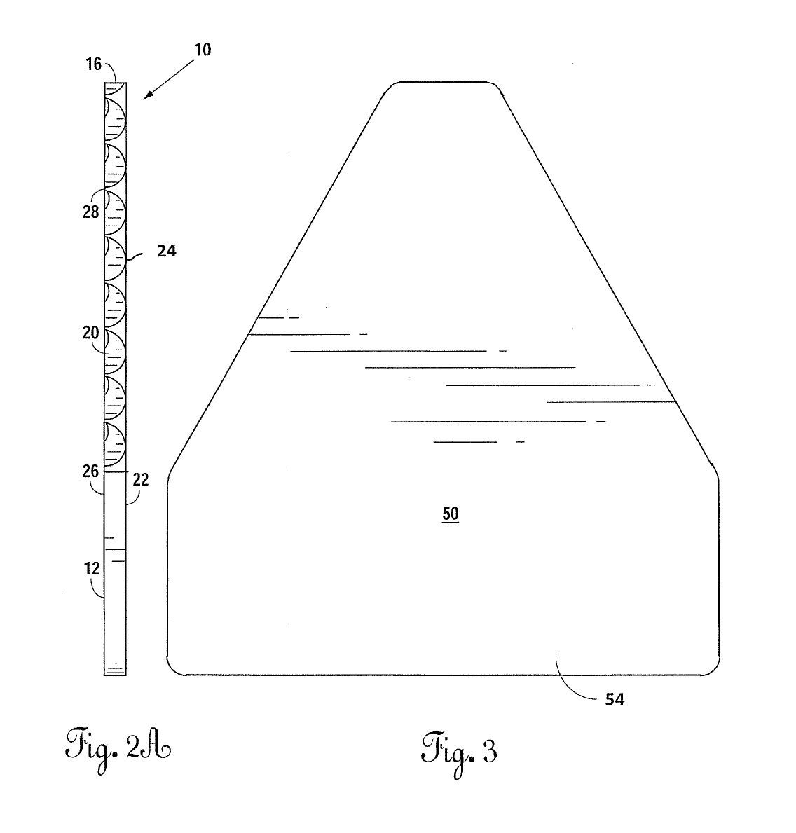

A still better understanding of the section knife 10 of the present invention may be had by understanding the method of its manufacture. The manufacturing process begins with a blank 50 having the perimeter of a truncated, generally isosceles triangle as shown in FIG. 3. This blank 50 is then formed to include substantially semi-circular channels 20 whose long axis is substantially parallel to the thickened base 54 of the blank 50 having the perimeter of a truncated, generally isosceles triangle.

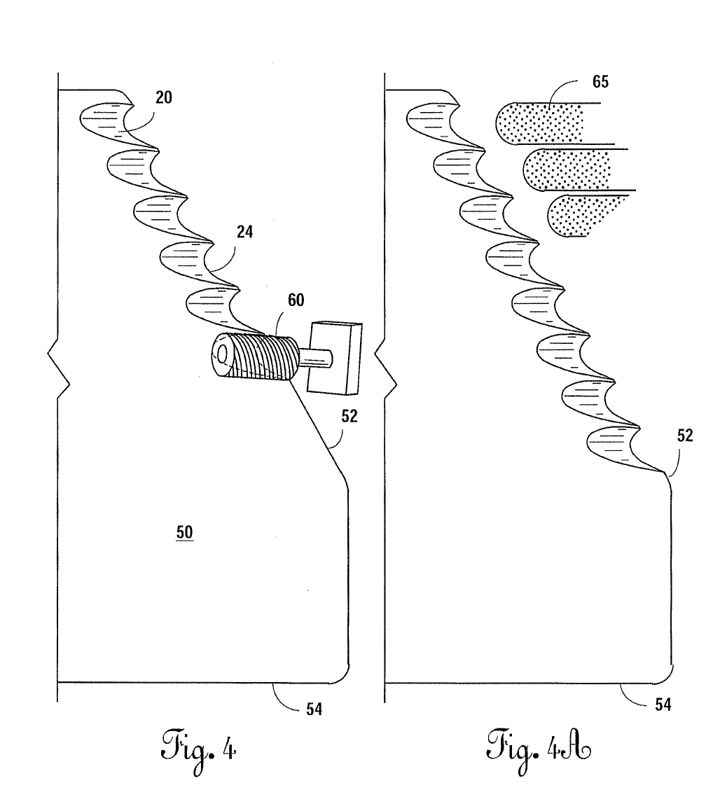

The substantially semi-circular channels 20 may be formed by a variety of different methods shown, in general, in FIG. 4. For example, a metal cutting tool, such as a grinding tool or side mill 60 or a tool including a set of multiple grinding tools or side mill 60, may be used to pass over the straight angled edge 52 of the blank 50. The path of the metal cutting tool 60 is substantially parallel to the base 54 of the truncated, generally isosceles triangle. Such path enables the grinding tool or side mill 60 to cut a substantially semi-circular channel 20 in the angled edge 52 of the blank 50 which substantially semi-circular channel 20 has a long axis substantially parallel to the thickened base 54 of the blank 50.

Other methods of forming the substantially semi-circular channels 20 whose long axis is parallel to the thickened base 54 of blank 50 may be used. Thus, instead of cutting the angled edge 52 of a blank 50 with a grinding tool or side mill 60, the substantially semi-circular channels 20 may be formed by stamping die or forcing a circular die such as a crush roller 65, shown in FIG. 4A, into the straight angled edges 52 of the blank 50.

When the substantially semi-circular channels 20 have been either formed or cut into the angled edges of a blank, the back surface of the blank 50 may be ground to sharpen the cutting edge 24 at the intersection of the bottom of the substantially semi-circular channel 20 and the back surface 22 of the blank 50. While, in the preferred embodiment, the back surface 22 of the blank 50 is ground to be smooth, grooves may be ground into the back surface of the blank 50. Such grooves may be helpful when cutting particular types of crops.

As section knives 10 are used on a variety of different pieces of equipment, one or more holes 30 may be formed in the body of thickened base 12 of the section knife 10. The size and spacing of the holes 30 in the body of thickened base 12 of the section knife 10 depends on the construction of the support structure to which the section knife 10 is mounted.

It has been found that when making the section knife 10 of the present invention, the number of substantially semi-circular grooves 20 formed in the angled edges 14 of the section knife 10 may vary between about three substantially semi-circular channels per inch to about twelve substantially semi-circular channels per inch. A larger number of substantially semi-circular channels per inch work best with crops having stems with a small diameter.

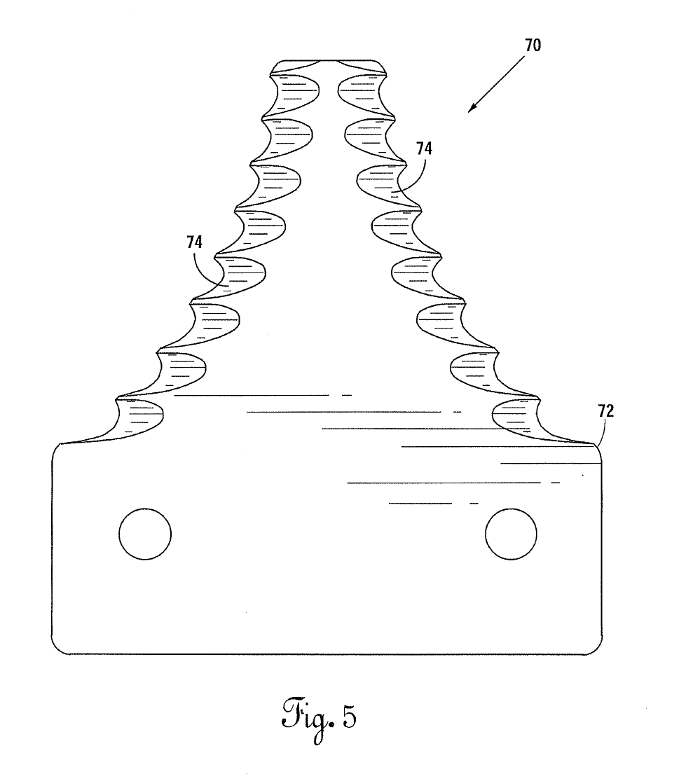

As shown in FIG. 5, it is also possible to form substantially semi-circular channels 74 in a section knife 70 whose angled edges 72 are formed to include a generally accurate or concave portion.

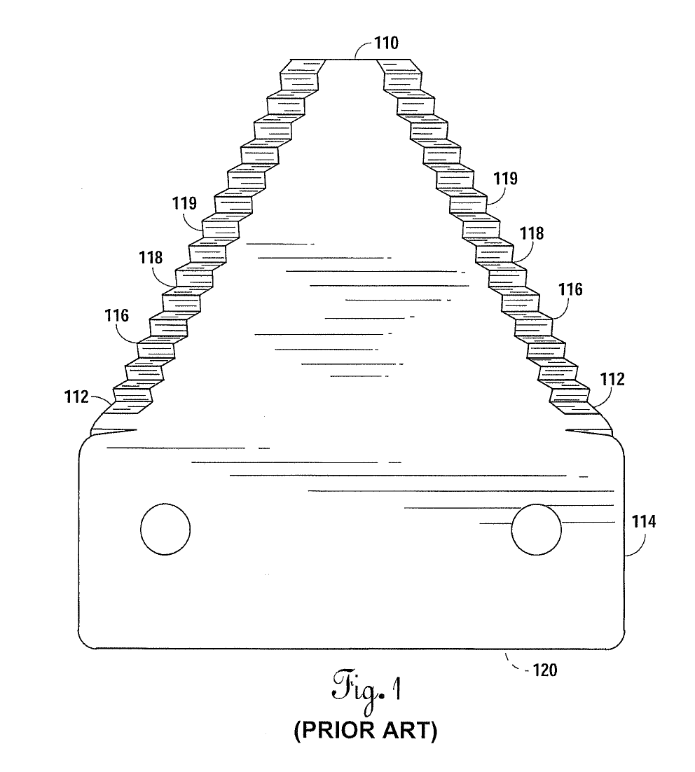

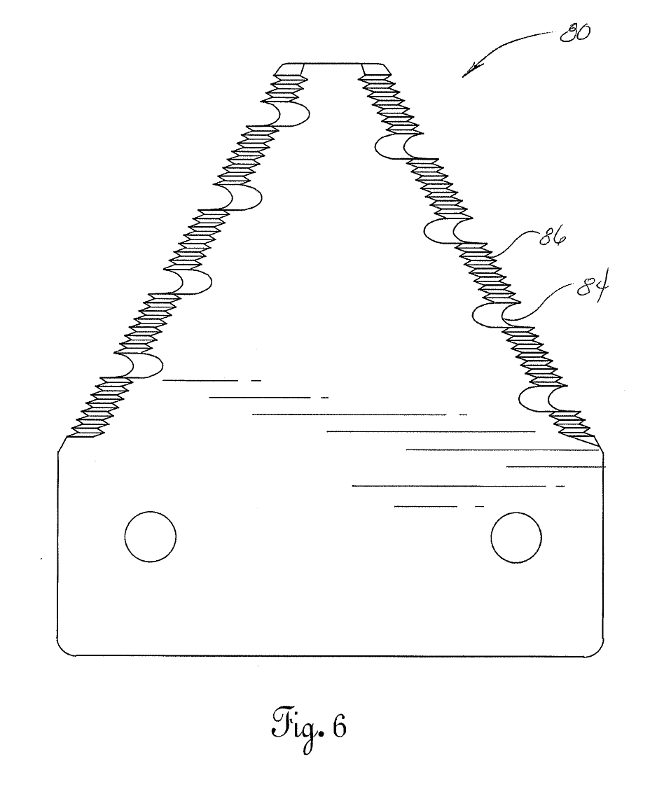

As shown in FIG. 6, substantially circular channels 84 may be interspersed between channels having other shapes in a second alternate embodiment of the section knife 80. For example, V-shaped channels are similar to those shown in FIG. 1 are shown in FIG. 6.

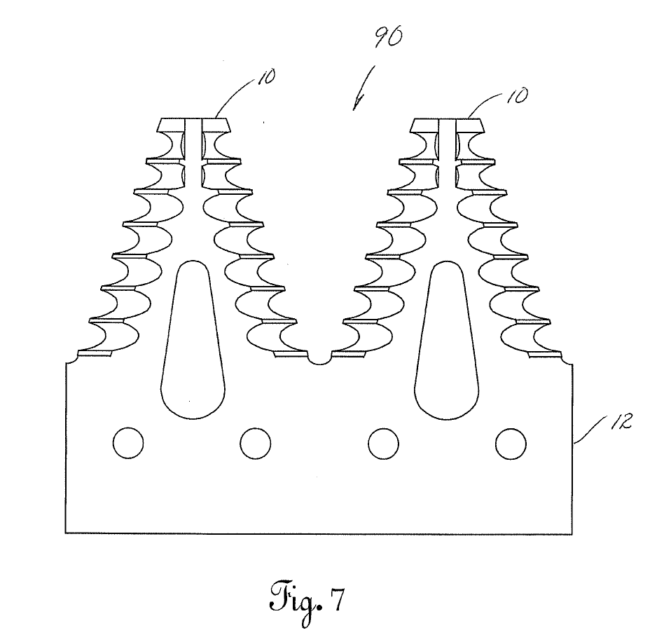

As shown in FIG. 7, two or more section knives 10 may be joined together at the thickened base 12 to form a third alternate embodiment of the section knife 90.

Once the section knife 10 has been formed and, if needed, sharpened by grinding the bottom surface 22 of the section knife 10, the completed section knife 10 may be coated with another metal whose wear or corrosion resistance further increases the life of the section knife 10. Alternatively, the completed section knife 10 may be treated metallurgically to increase its service life. Further, another alternative is to coat the section knife of the present invention with a wear-resistant or low-friction polymer coating.

Yet another manufacturing method may include casting a blank having the perimeter of a truncated, generally isosceles triangle wherein the edges of the cast blank include substantially semi-circular channels whose long axes are substantially parallel to the thickened base of the truncated, generally isosceles triangle. After being cast, the cast blank with substantially semi-circular channels formed therein may then be sharpened by grinding the bottom surface of the cast blank and/or the surface of the substantially semi-circular channel.

Use and testing of the section knife of the present invention have revealed the following advantages. The unique geometry of the substantially semi-circular channels which extend from the front surface of the section knife to the back surface of the section knife makes it self-sharpening. In addition to being self-sharpening, the section knife of the present invention enables a relatively smooth or straight cut of the vegetable matter as opposed to the ragged cut made by many prior art section knives. Such smooth or straight cut produces quicker re-growth of a plant than re-growth when there is a ragged cut.

In addition to enabling the cutting of cereal grains, soy beans, hay and grasses, the unique geometry of the section knife of the present invention has found applicability in other applications such as the cutting of tomato plant stems or stalks just under the surface of the soil. In addition, the section knife of the present invention may be used for the cutting the stems or stalks of aquatic plants.

While the section knife of the present invention has been described according to its preferred and alternate embodiments, those of ordinary skill in the art will understand that additional modifications and changes may be made to the disclosed section knife. Such modifications and changes shall fall within the scope and meaning of the appended claims.

What is claimed is:

1. A section knife made according to a process comprising:
forming a metal blank having a back surface and a front surface and a perimeter in the form of a truncated generally isosceles triangle, said truncated isosceles triangle having a thickened base and angled sides;
engaging said angled sides with a forming tool to create substantially semi-circular channels, said substantially semi-circular channels being oriented substantially parallel to said thickened base , said substantially semi-circular channels running from said back surface to said front surface.

2. The section knife made according to the process defined in claim 11 further including grinding said back surface to form a cutting edge at the intersection of said substantially semi-circular channel and said back surface.

3. The section knife made according to the process defined in claim 11 wherein said angled edges contain from about three substantially semi-circular channels per inch to about twelve substantially semi-circular channels per inch.

4. The section knife made according to the process defined in claim 11 wherein all or a portion of the outer surface of said section knife is coated with another metal.

5. A section knife made according to a process comprising:
forming a metal blank having a back surface and a front surface and a perimeter in the form of a truncated generally isosceles triangle, said truncated isosceles triangle having a thickened base and angled sides;
engaging said angled sides with a cutting tool to create substantially semi-circular channels, said substantially circular channels being oriented substantially parallel to said thickened base, said substantially semi-circular channels running from said front surface to said back surface.

6. The section knife made according to the process defined in claim 15 further including grinding said back surface to form a cutting edge at the intersection of said substantially semi-circular channel and said back surface.

7. The section knife made according to the process defined in claim 15 wherein said angled sides contain from about three substantially semi-circular channels per inch to about twelve substantially semi-circular channels per inch.

8. The section knife made according to the process defined in claim 15 wherein all or a portion of the outer surface of the section knife is coated with another metal.

9. A section knife made according to a process comprising:
forming a metal blank having a front surface and a back surface and the perimeter of a truncated generally isosceles triangle, said truncated isosceles triangle having a thickened base and angled sides, said angled sides further including substantially semi-circular channels oriented substantially parallel to said thickened base, said substantially semi-circular channels running from said front surface to said back surface;
grinding said back surface of said formed metal blank to form a sharpened surface at the intersection of said substantially semi-circular channel and said back surface.
